(19) United States
(12) Patent Application Publication
(10) Pub. No.: US 2013/0284981 A1
(43) Pub. Date: Oct. 31, 2013

(54) Filtering Structure Coated with Catalyst for Reforming Synthesis Gas and Filtering Method Using the Same

(71) Applicants: Jin Hong Kim, Daejeon (KR); Jeong Mook Kim, Daegu (KR); Ok Youn Kim, Daejeon (KR); Joo Won Park, Daejeon (KR); Seung Hoon Oh, Seoul (KR); Hyun Min Shim, Daejeon (KR); Gyoo Tae Kim, Daejeon (KR); Young Eun Choen, Daejeon (KR); Ja Hyun Yang, Seoul (KR)

(72) Inventors: Jin Hong Kim, Daejeon (KR); Jeong Mook Kim, Daegu (KR); Ok Youn Kim, Daejeon (KR); Joo Won Park, Daejeon (KR); Seung Hoon Oh, Seoul (KR); Hyun Min Shim, Daejeon (KR); Gyoo Tae Kim, Daejeon (KR); Young Eun Choen, Daejeon (KR); Ja Hyun Yang, Seoul (KR)

(73) Assignee: SK INNOVATION CO, LTD, Seoul (KR)

(21) Appl. No.: 13/978,490

(22) PCT Filed: Jan. 6, 2012
(86) PCT No.: PCT/KR2012/000143

§ 371 Date: Jul. 5, 2013

(30) Foreign Application Priority Data
Jan. 7, 2011 (KR) 10-2011-0001768

(51) Int. Cl. C01B 3/02; B01D 53/46

(52) U.S. Cl. CPC C01B 3/02; B01D 53/46
USPC 252/373; 422/162

(57) ABSTRACT

Embodiments of the invention provide filtering structures and methods. At least filtering structure includes a filtering medium for removing impurities from a gas produced by gasifying coal or biomass, and a catalyst for converting methane and carbon dioxide into synthesis gas by a dry reforming reaction and a steam reforming reaction. The filtering medium, according to various embodiments, is coated with the catalyst.

### RELATED APPLICATIONS

This application is related to, and claims priority to, PCT Patent Application No. PCT/KR2012/000143, filed on Jan. 6, 2012, which claims priority to Korean Patent Application Serial No. 10-2011-0001768, filed on Jan. 7, 2011, the disclosures of which are incorporated herein by reference in their entirety.

BACKGROUND

1. cl Field of the Invention

The present invention relates to a filtering structure coated with a catalyst for reforming synthesis gas and a filtering method using the same.

2. Description of Related Art

Generally, gasification is an old classical technology for converting solid feedstocks into inflammable gas fuel, but has been undergoing development recently. In the history of human fuel, trees, which are being used for cooking or heating even now, have been changed into coal, gas, oil, electricity, etc.

Synthesis gas is produced from natural gas, coal, biomass, extra heavy oil, etc., and includes hydrogen and carbon monoxide. Such synthesis gas can be formed into diesel, naphtha, lubricant, or the like, through a Fischer-Tropsch process. Such synthesis gas started to be used for city street lights, after which it was used as an alternative to solid fuels or used to manufacture chemical raw materials. Recently, synthesis gas has been used to produce power or to manufacture synthetic fuel or chemicals.

Synthesis gas can be produced by the gasification of solid feedstocks, such as coal, biomass, waste, or the like, or by the reforming reaction of natural gas, or the like. A general process of producing synthesis gas by the gasification of solid feedstocks includes the steps of: introducing a raw material, such as coal, biomass or the like, into a gasifier for gasifying the raw material to produce synthesis gas including hydrogen, carbon monoxide, and the like; and removing impurities, such as dust, sulfur compounds, nitrogen compounds, and the like, from the produced synthesis gas. The synthesis gas produced in this way is used to manufacture chemical products, such as synthetic fuel, methanol, and the like, and to generate electric power.

Generally, the dust discharged from a gasifier includes carbon particles, such as micro-ash and soot, and can be removed by a filtering unit disposed at the rear end of the gasifier. In the low-temperature filtering unit, a ceramic filter is used, and the particle size of removable dust is determined by the size of the pores.

The gas that is finally discharged includes a large amount of other materials, such as methane, carbon dioxide, and the like, in addition to synthesis gas. Particularly, methane and carbon dioxide are referred to as greenhouse gases and cause global warming. Nowadays, the Tokyo Protocol requires the reduction in greenhouse gases. Therefore, every country is liable for reducing the discharge of greenhouse gases (carbon dioxide, etc.), and determines the annual allowable greenhouse gas discharge. In this case, enterprises and countries, which cannot reduce their allocation of greenhouse gas discharge must purchase a greenhouse gas discharge right from enterprises or countries which have reduced more than their required amount of discharged greenhouse gases (carbon dioxide, etc.), thereby accomplishing the objective of reducing greenhouse gases. Accordingly, in a situation wherein the reduction in greenhouse gases (carbon dioxide, etc.) has become a nation's absolute obligation, research into methods of reducing greenhouse gas is required. However, the method of reducing greenhouse gases that is currently being generally used is a method of collecting and storing carbon dioxide using adsorption, absorption, or the like, which requires additional costs and energy consumption because additional processes must be conducted.

As described above, conventionally, the gas discharged from a gasifier is denitrified and desulfurized, filtered to remove dust therefrom, and then discharged to the outside. The discharged gas includes methane, carbon dioxide, etc., which are the main materials causing global warming. Thus, regulations for reducing these materials are tightened, so that there is a problem in that additional separation and treatment processes are required in order to reduce these materials.

### SUMMARY

Embodiments of the invention demonstrate that synthesis gas produced by the gasification of a solid feedstock, such as coal, biomass, wastes, or the like, can be filtered using a filtering structure coated with a catalyst to remove impurities, such as dust, and the like, therefrom, and also that a greenhouse gas, such as carbon dioxide, methane, or the like, produced during the gasification of the solid feedstock can be converted into synthesis gas.

Accordingly, embodiments of the invention provide a filtering structure coated with a catalyst for converting methane, carbon dioxide, and the like into synthesis gas, whereby the filtering structure is used in a process for producing synthesis gas.

Further, embodiments of the invention provide a filtering method using the filtering structure.

In particular, in accordance with at least one embodiment, there is provided a filtering structure including a filtering medium for removing impurities from a gas produced by gasifying coal or biomass. The filtering structure further includes a catalyst for converting methane and carbon dioxide into a synthesis gas by a dry reforming reaction and a steam reforming reaction. The filtering medium is coated with the catalyst.

In accordance with another embodiment, the catalyst of the filtering structure includes at least one support selected from the group consisting of oxides of Al, Y, Zr, La, Si, Ti, and Ce, at least one transition metal-based active material selected from the group consisting of Ni, Rh, Pt, Pd, Ru, Ir and Co, and at least one promoter selected from the group consisting of Na, Mg, K, Ca, Pd, Pt, Rh, Ru, Fe, and Cu.

In accordance with another embodiment, the filtering structure is formed using any one of a metal mesh, a metal fiber, and a sintered body of metal powder.

In accordance with another embodiment, there is provided a filtering unit including a filtering structure, which includes a filtering medium for removing impurities from a gas produced by gasifying coal or biomass. The filtering structure further includes a catalyst for converting methane and carbon dioxide into a synthesis gas by a dry reforming reaction and a steam reforming reaction. The filtering medium is coated with the catalyst.

In accordance with another embodiment, there is provided a filtering method, which includes the steps of gasifying coal or biomass to obtain a gas mixture, removing nitrogen or sulfur from the gas mixture, and passing the gas mixture through a filtering structure to remove dust from the gas mixture and convert methane and carbon dioxide into synthesis gas by a dry reforming reaction and a steam reaction. The filtering structure includes a filtering medium for removing impurities from a gas produced by gasifying coal or biomass. The filtering structure further includes a catalyst for converting methane and carbon dioxide into a synthesis gas by a dry reforming reaction and a steam reforming reaction. The filtering medium is coated with the catalyst.

In accordance with another embodiment, wherein the dry reforming reaction and the steam reforming reaction are conducted at a temperature range of 650˜900° C.

In accordance with another embodiment, wherein the filtering method further includes the step of selectively removing impurities from a surface of the filtering structure before coating the filtering structure with a catalyst for converting the methane and the carbon dioxide into the synthesis gas.

### BRIEF DESCRIPTION OF THE DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a block diagram showing a gasification process, which can remove impurities using a filtering structure coated with a catalyst for reforming synthesis gas and can produce synthesis gas, in accordance with an embodiment of the invention.

FIG. 2 is a schematic view showing a filtering structure coated with a catalyst for reforming synthesis gas, in accordance with an embodiment of the invention.

### DETAILED DESCRIPTION

Although the following detailed description contains many specific details for purposes of illustration, it is understood that one of ordinary skill in the relevant art will appreciate that many examples, variations, and alterations to the following details are within the scope and spirit of the invention. Accordingly, the exemplary embodiments of the invention described herein are set forth without any loss of generality, and without imposing limitations, relating to the claimed invention.

Embodiments of the invention provide a filtering structure, including a filtering medium having pores for removing impurities, such as dust, and the like, from the gas produced by gasification of a solid raw material such as coal, biomass, or the like, and a catalyst for converting methane and carbon dioxide into synthesis gas by a dry reforming reaction and a steam reforming reaction, wherein the filtering medium is coated with the catalyst.

Because the filtering structure is coated with the catalyst for converting hydrocarbons into synthesis gas, it can conduct both a filtering function for removing impurities and a function for converting hydrocarbons into synthesis gas.

The catalyst may include at least one support selected from the group consisting of oxides of Al, Y, Zr, La, Si, Ti, and Ce, at least one transition metal-based active material selected from the group consisting of Ni, Rh, Pt, Pd, Ru, Ir and Co, and at least one promoter selected from the group consisting of Na, Mg, K, Ca, Pd, Pt, Rh, Ru, Fe, and Cu. The support provides proper textural properties for the transition metal-based active material and the promoter enhances dry reforming and steam reforming reaction.

In accordance with at least one embodiment, the support has a specific surface area of 30 m²/g-300 m²/g.

In accordance with at least one embodiment, the transition metal-based active material is included in an amount of 0.5-20 wt % based on the amount of the support.

In accordance with at least one embodiment, the filtering structure is formed using anyone of a metal mesh, a metal fiber, and a sintered body of metal powder.

In accordance with another embodiment, there is provided a filtering method, including the steps of gasifying coal or biomass to obtain a gas mixture, removing nitrogen or sulfur from the gas mixture, and passing the gas mixture through the filtering structure coated with a catalyst for converting hydrocarbons into synthesis gas to remove dust from the gas mixture and convert methane and carbon dioxide into synthesis gas.

In accordance with at least one embodiment, the reaction temperature of the catalyst for converting hydrocarbons into synthesis gas may be 650-900° C.

In accordance with at least one embodiment, the space velocity (GHSV) of the gas mixture flowing into the catalyst for converting hydrocarbons into synthesis gas may be 1,000-50,000 h⁻¹.

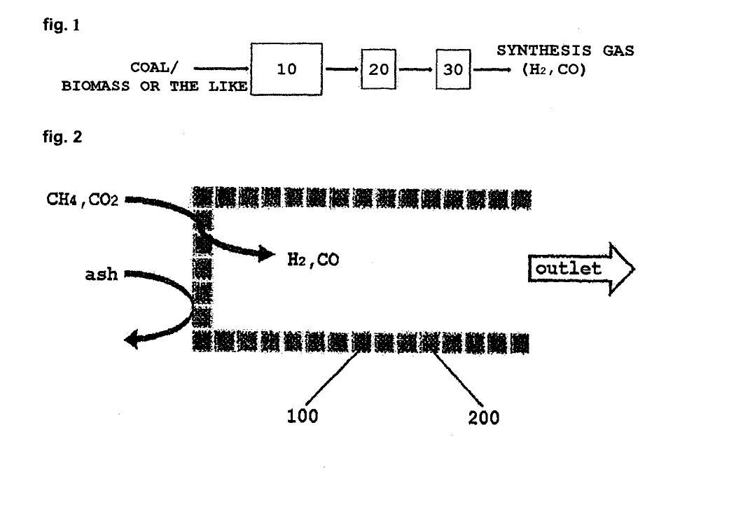

As shown in FIG. 1, a gasification process, using the filtering structure in accordance with at least one embodiment of invention, includes a gasifier 10 for gasifying a raw material, a denitrification-desulfurization unit 20 for removing nitrogen compounds and sulfur compounds from the gas discharged from the gasifier 10, and a filtering unit 30 for removing dust, and the like. The filtering unit 30 includes a filter structure coated with a catalyst for converting greenhouse gas into synthesis gas.

As shown in FIG. 2, dust, and the like, are removed by a filtering structure 200 constituting the filtering unit of various embodiments of the invention, and methane and carbon dioxide are converted into hydrogen and carbon monoxide by the catalyst 100 applied on the filtering structure 200 and then discharged to the outside.

Particularly, embodiments of the invention relate to a filtering structure coated with a catalyst for reforming synthesis gas. The catalyst applied on the filtering structure serves to convert a greenhouse gas, such as methane, carbon dioxide, or the like, into synthesis gas, such as hydrogen, carbon monoxide, or the like. When the filtering structure is coated with the catalyst, at least one of a dry reforming reaction and a steam reforming reaction take place at the surface of the filtering structure coated with the catalyst, so that a byproduct, such as methane, carbon dioxide, or the like, is converted into synthesis gas, such as hydrogen, carbon monoxide, or the like, thereby both increasing the conversion rate of greenhouse gas into synthesis gas and performing the original filtering function of the filtering unit.

In a process of producing synthesis gas, in accordance with an embodiment of the invention, the gas discharged after denitrification/desulfurization includes various compounds, for example, hydrogen, nitrogen, methane, carbon dioxide, water vapor, etc., in addition to hydrogen and carbon monoxide. Further, the temperature of the discharged gas, which underwent a gasification reaction before it was introduced into the filtering unit, may be 800° C. or more as long as cooling or heat exchange is not additionally performed. Since the catalyst efficiently acts at this temperature, additional heating is not required, thus improving energy efficiency.

The following Reaction Formulae 1 and 2 represent the dry reforming reaction and steam reforming reaction of methane, which is a hydrocarbon.

[Reaction Formula 1]

CH₄+CO₂˜2 H₂+2 CO ΔH_{R}=247.3 kJ/mol

[Reaction Formula 2]

CH₄+H₂O˜3 H₂+CO ΔH_{R}=206.0 kJ/mol

The above Reaction Formulae 1 and 2 show the dry reforming reaction and steam reforming reaction of methane whereby carbon dioxide and water vapor react with methane to form hydrogen and carbon monoxide (e.g., synthesis gas). In accordance with at least one embodiment, the dry reforming reaction and steam reforming reaction are performed at a temperature range of 650-900° C., and in another embodiment are preferably performed at 750-850° C. In accordance with various embodiments, the filtering pressure is 0.5-50 kg_{f}/cm².

In accordance with various embodiments, methane and carbon dioxide, as represented by Reaction Formula 1 above, are converted into hydrogen and carbon monoxide by the dry reforming reaction. Further, methane, as represented by Reaction Formula 2 above, is converted into synthesis gas in the presence of water vapor by the steam reforming reaction.

In accordance with an embodiment of the invention, a support to be supported with a catalyst is selected from oxides of Al, Y, Zr, La, Si, Ti and Ce, and composite oxides thereof.

In accordance with an embodiment of the invention, in consideration of adhesivity on the filtering structure, the support is selected from oxides of Al and Si, and composite oxides thereof.

In accordance with an embodiment of the invention, the support has a specific surface area of 30 m²/g-300 m²/g, which is preferable in terms of increasing the dispersity of a catalyst, particularly, a precious metal catalyst.

In accordance with an embodiment of the invention, an active material for improving the chemical activity of the catalyst used in the reforming reactions is selected from the group consisting of Ni, Rh, Pt, Pd, Ru, Ir and Co. In accordance with at least one embodiment, Ni is preferable in terms of high activity and low price, and Rh, Pt, Pd and Ru are preferable in terms of high activity and stability.

In accordance with an embodiment of the invention, the active material is included in an amount of 0.5-20 wt % based on the support. When Ni or Co is used as the active material, the active material is included in an amount of 5-20 wt %. Further, when Rh, Pt, Pd, Ru or Ir is used as the active material, the active material is included in an amount of 0.5-5 wt %.

In accordance with an embodiment of the invention, in order to change the activity on the support or the active material or to improve the stability and activity of the catalyst by changing the shape thereof, at least one promoter selected from the group consisting of Na, Mg, K, Ca, Pd, Pt, Rh, Ru, Fe, and Cu is used as an activity promoter.

In accordance with an embodiment of the present invention, the filtering structure, which is used to remove dust from the synthesis gas produced by the gasification of coal or biomass, is made of a metal material or a ceramic material. In accordance with an embodiment of the invention, the filtering structure is made of a metal material because the heat necessary for Reaction Formulae 1 and 2 is easily transferred from a metal material. The filtering structure has pores for filtering dust and passing gas. Concretely, the filtering structure is formed using a metal mesh, a metal fiber, and a sintered body of metal powder.

In accordance with an embodiment of the invention, the size of the pores of the filtering structure are determined by the particle size of the dust to be removed. Each of the pores has a size of 0.1-10 μm, and in another embodiment has a size of 0.5-5 μm.

In accordance with an embodiment of the invention, be fire the filtering structure is coated with the catalyst for converting greenhouse gas into synthesis gas, a process of removing impurities from the surface of the filtering structure is selectively conducted. Concretely, the filtering structure is washed with an alcohol or ketone solvent, such as methanol, acetone, or the like. In order to remove residue, which cannot be washed off and improve the adhesivity of the catalyst to the filtering structure, the filtering structure is heat-treated under a stream of air or oxygen. The heat-treatment of the filtering structure is performed at 500-950° C. for 0.5-12 hours.

In accordance with an embodiment of the invention, the space velocity (GHSV) of the discharged gas flowing into the catalyst for converting hydrocarbons into synthesis gas is 500-50,000 h⁻¹, and in another embodiment 1,000-10,000 h⁻¹.

In accordance with an embodiment of the invention, in order to coat the filtering structure with the catalyst for converting hydrocarbons into synthesis gas, the filtering structure is directly coated with the catalyst having the above composition or is coated with the catalyst by adding a coating additive, such as alumina sol, silica sol, or the like, at the time of combining the catalyst. In accordance with another embodiment, the filtering structure is coated with the catalyst by applying the support onto the filtering structure using a thermal spraying method or a chemical deposition method and then the active materials including promoters are coated on the filtering structure by the method of spraying or impregnation.

According to and embodiment of the invention, in order to remove the dust or the like generated by the gasification of coal, or the like, the filtering structure coated with the catalyst for converting hydrocarbons into synthesis gas is mounted in the filtering unit necessary for producing synthesis gas, so that methane and carbon dioxide included in the side products are converted into synthesis gas including hydrogen and carbon monoxide by at least one of the dry reforming reaction and the steam reforming reaction arising from the surface of the filtering structure, and simultaneously dust, or the like, is filtered.

Hereinafter, embodiments of the invention will be described in more detail with reference to the following Examples and Comparative Examples. However, the scope of the invention is not limited to these Examples.

### COMPARATIVE EXAMPLE 1

The composition of synthesis gas, given in Table 1 below, was obtained as a result of operating a circulating fluidized bed gasifier having a capacity of 50 kg/day. The gasifier was operated at a temperature of 950° C. and a pressure of 5 kg_{f}/cm².

TABLE 1
Table 1: Composition of synthesis gas
after denitrification and desulfurization

| Gas Composition | Relative Amount (wet. mol %) |
|---|---|
| H₂ | 10.55 |
| N₂ | 35.22 |
| CH₄ | 0.76 |
| CO | 15.11 |
| CO₂ | 8.31 |
| H₂O | 30.06 |
| Sum | 100 |

### PREPARATION EXAMPLE 1

A filter made of Fe—Cr—Al was coated with a catalyst and a support. First, a coating solution was prepared using alumina-ceria mixture powder having a particle size of 1 μm, a sol-type alumina solution and a palladium salt (e.g., palladium nitrate). The filter was washed with methanol and then heat-treated at 600° C. for 2 hours to remove impurities from the surface thereof before the filter was coated. The filter coated with a catalyst and a support was air-knifed, dried at 120° C. for 4 hours to remove water therefrom, and was then sintered at 800° C. to form a catalytic filter. The above procedure was repeated twice to the catalytic filter, and, in this case, the amount of the palladium catalyst applied on the catalytic filter was set to 5% of the amount of the support.

### EXAMPLE 1

The catalytic filter formed in Preparation Example 1 was mounted in the gasifier of Comparative Example 1, and then the composition of synthesis gas and the reduction rate of greenhouse gas were measured. The results thereof are given in Tables 2 and 3 below. The temperature of synthesis gas flowing into the catalytic filter was 800° C., and the pressure thereof was 5 kg_{f}/cm². Methane in the synthesis gas that had passed through the catalytic filter was reformed by 50%. 60% of the reformed methane was converted into hydrogen and carbon monoxide by a dry reforming reaction, and 40% of the reformed methane was converted into hydrogen and carbon monoxide by a steam reforming reaction.

TABLE 2
Table 2: Composition of synthesis gas after catalytic
filtration process

| Gas Composition | Relative Amount (wet. mol %) |
|---|---|
| H₂ | 11.32 |
| N₂ | 34.90 |
| CH₄ | 0.52 |
| CO | 15.60 |
| CO₂ | 7.98 |
| H₂O | 29.67 |
| Sum | 100 |

TABLE 3
Table 3: Effects of catalytic filtration process for reforming
CH₄ or CO₂ included in the synthesis gas (reduction
rate of greenhouse gas and increase rate of H₂ and CO)

| Gas composition | Reduction rate (%) | Increase rate (%) |
|---|---|---|
| CH₄ | 31.0 | |
| CO₂ | 4.5 | |
| Sum | 6.69 | |
| H₂ | | 6.77 |
| CO | | 2.67 |

Embodiments of the invention provide non-obvious advantages over conventional filtering structures and processes. For example, various embodiments provide a filtering structure coated with a catalyst for reforming synthesis gas and a filtering method using the same. In accordance with certain embodiments of the invention, methane and carbon dioxide or methane and water vapor are converted into synthesis gas, while removing impurities, such as dust, and the like, so that an additional process of separating and treating greenhouse gas, such as carbon dioxide, methane, or the like, is not required. As a result, facilities for carrying out additional treatments are not required, thereby reducing additional costs and increasing the production yield of synthesis gas. Further, various embodiments provide a filtering structure coated with a catalyst for reforming synthesis gas and a filtering method using the same, whereby the amount of the discharge of carbon dioxide, methane, or the like can be reduced, thus providing an environment-friendly effect. Furthermore, since the filtering process is conducted at high temperature, energy loss attributable to the additional heat supply can be prevented in subsequent processes to be conducted at high temperatures.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

We claim:

1. A filtering structure, comprising:
a filtering medium configured to remove impurities from a gas produced by gasifying coal or biomass; and
a catalyst configured to convert methane and carbon dioxide into a synthesis gas by a dry reforming reaction and a steam reforming reaction,
wherein the filtering medium is coated with the catalyst.

2. The filtering structure according to claim 1, wherein the catalyst comprises at least one support selected from the group consisting of oxides of Al, Y, Zr, La, Si, Ti, and Ce; at least one transition metal-based active material selected from the group consisting of Ni, Rh, Pt, Pd, Ru, Ir and Co; and at least one promoter selected from the group consisting of Na, Mg, K, Ca, Pd, Pt, Rh, Ru, Fe, and Cu.

3. The filtering structure according to claim 1, wherein the filtering structure is formed using any one of a metal mesh, a metal fiber, and a sintered body of metal powder.

4. A filtering unit, comprising the filtering structure of claim 1.

5. A filtering method, comprising the steps of:
gasifying coal or biomass to obtain a gas mixture;
removing nitrogen or sulfur from the gas mixture; and
passing the gas mixture through the filtering structure of claim 1 to remove dust from the gas mixture and convert methane and carbon dioxide into synthesis gas by a dry reforming reaction and a steam reforming reaction.

6. The filtering method according to claim 5, wherein the dry reforming reaction and the steam reforming reaction are conducted at a temperature range of 650˜900° C. .

7. The filtering method according to claim 5, further comprising the step of selectively removing impurities from a surface of the filtering structure before coating the filtering structure with a catalyst for converting the methane and the carbon dioxide into the synthesis gas.
